(19) United States
(12) Patent Application Publication
(10) Pub. No.: US 2024/0429569 A1
(43) Pub. Date: Dec. 26, 2024

(54) SECONDARY BATTERY

(71) Applicant: TOYOTA JIDOSHA KABUSHIKI KAISHA, Toyota-shi (JP)

(72) Inventors: Masahiro ISHIZUKA, Toyota-shi (JP); Kosuke SUZUKI, Toyota-shi (JP); Hideto MORI, Nisshin-shi (JP); Mitsuru TATEISHI, Toyota-shi (JP); Shinya ISHIKAWA, Toyota-shi (JP); Mari TARUTANI, Nagoya-shi (JP); Kenta KIMURA, Toyota-shi (JP)

(73) Assignee: TOYOTA JIDOSHA KABUSHIKI KAISHA, Toyota-shi (JP)

(21) Appl. No.: 18/733,134

(22) Filed: Jun. 4, 2024

(30) Foreign Application Priority Data
Jun. 22, 2023 (JP) 2023-102398

(51) Int. Cl. H01M 50/533; H01M 50/103; H01M 50/15; H01M 50/548

(52) U.S. Cl. CPC H01M 50/533; H01M 50/103; H01M 50/15; H01M 50/548

(57) ABSTRACT

A secondary battery includes: an electrode assembly including a first end portion where one or more negative electrode tabs are formed, and a second end portion where one or more positive electrode tabs are formed; a housing containing the electrode assembly; and a negative electrode terminal and a positive electrode terminal provided on the housing, the housing includes a main body, a first sealing body, and a second sealing body, the negative electrode terminal is provided on the first sealing body, the positive electrode terminal is provided on the second sealing body, the one or more negative electrode tabs are electrically connected to the negative electrode terminal, the one or more positive electrode tabs are electrically connected to the positive electrode terminal, and one of the one or more negative electrode tabs and the one or more positive electrode tabs is larger in length than the other.

### CROSS REFERENCE TO RELATED APPLICATIONS

This nonprovisional application is based on Japanese Patent Application No. 2023-102398 filed on Jun. 22, 2023 with the Japan Patent Office, the entire contents of which are hereby incorporated by reference.

### BACKGROUND

### Field

The present disclosure relates to a secondary battery, and more particularly, to a secondary battery mounted on a vehicle.

### Description of the Background Art

As a conventional secondary battery, U.S. Patent Application Publication No. 2022/0302533 discloses a configuration in which openings of a case main body whose both sides in the longitudinal direction are open in a housing for housing an electrode assembly are closed by lid members provided with external terminals.

### SUMMARY

In the secondary battery disclosed in U.S. Patent Application Publication No. 2022/0302533, an external terminal and a current collector are assembled in advance with a lid member to form a lid assembly, and then an electrode tab provided on an electrode assembly is fixed to the current collector of the lid assembly. Subsequently, the opening of the case body is closed by the lid assembly with the electrode tab fixed to the current collector.

Specifically, first, on one side in the longitudinal direction, an electrode tab (for example, a positive electrode tab) of an electrode assembly is connected to a current collector of the lid assembly, and the opening of the case body is closed by the lid assembly. Subsequently, the electrode tab (e.g., the negative electrode tab) of the electrode assembly is connected to the current collector of the lid assembly on the other longitudinal side, and the opening of the case body is closed by the lid assembly.

Depending on the state in which the current collector and the electrode tab are fixed to each other on one side in the longitudinal direction, there is a concern that the electrode tab is pulled and fixed to the current collector on the other side in the longitudinal direction. In this case, when there is no measures, the entire electrode assembly is pulled, and the electrode assembly may be damaged.

The present disclosure is given in view of the above problems, and it is an object of the present disclosure to provide a secondary battery capable of suppressing breakage of an electrode assembly.

A secondary battery according to the present disclosure includes: an electrode assembly including a first end portion located on one side in a first direction, and a second end portion located on the other side in the first direction, one or more negative electrode tabs being formed on the first end portion, and one or more positive electrode tabs being formed on the second end portion; a housing containing the electrode assembly; and a negative electrode terminal and a positive electrode terminal that are provided on the housing. The housing includes: a main body provided with a first opening on the one side in the first direction, and a second opening on the other side in the first direction; a first sealing body closing the first opening; and a second sealing body closing the second opening. The negative electrode terminal is provided on the first sealing body. The positive electrode terminal is provided on the second sealing body. The one or more negative electrode tabs are electrically connected to the negative electrode terminal. The one or more positive electrode tabs are electrically connected to the positive electrode terminal. One of: i) the one or more negative electrode tabs; and ii) the one or more positive electrode tabs, is larger in length than the other of: i) the one or more negative electrode tabs; and ii) the one or more positive electrode tabs.

In the above-described configuration, one of the positive electrode tab and the negative electrode tab is electrically connected to one external terminal, which is one of the positive electrode terminal and the negative electrode terminal and has the same polarity as the one of the positive and negative electrode tabs. The other of the positive electrode tab and the negative electrode tab is electrically connected to the other external terminal, which is the other of the positive electrode terminal and the negative electrode terminal. The one external terminal is provided on one of the first sealing body and the second sealing body. The other external terminal is provided on the other of the first sealing body and the second sealing body. The one sealing body closes one of the first opening and the second opening. The other sealing body closes the other of the first opening and the second opening.

In the process of assembling the secondary battery, in the state where the other electrode tab is electrically connected to the other external terminal and the other opening of the main body is closed by the other sealing body, the one electrode tab is electrically connected to the one external terminal and the one opening is closed by the one sealing body. At this time, the one electrode tab is longer than the other electrode tab. Therefore, the one sealing body can be assembled with the one opening while adjusting the degree of sagging of the one electrode tab. As a result, the force applied to the electrode assembly can be suppressed and breakage of the electrode assembly can be suppressed.

In the secondary battery according to the present disclosure, the one of: i) the one or more negative electrode tabs; and ii) the one or more positive electrode tabs, may sag to a greater extent than the other of: i) the one or more negative electrode tabs; and ii) the one or more positive electrode tabs.

In the above-described configuration, one electrode tab sags to a greater extent than the other electrode tab, so that the force applied to the electrode assembly can more reliably be suppressed.

In the secondary battery according to the present disclosure, the main body includes a first wall portion and a second wall portion that are opposite to each other in a second direction orthogonal to the first direction. The first wall portion is located on one side in the second direction. The second wall portion is located on the other side in the second direction. The electrode assembly includes a third end portion located on the one side in the second direction, and a fourth end portion located on the other side in the second direction. In this case, the one of: i) the one or more negative electrode tabs; and ii) the one or more positive electrode tabs, may include a portion sagging away from the third end portion, toward the first wall portion, or a portion sagging away from the fourth end portion, toward the second wall portion.

In the above-described configuration, the adjustable degree of sagging of one of the electrode tabs can be kept large. Thus, the electrode assembly can stably be connected electrically to the positive electrode terminal and the negative electrode terminal.

In the secondary battery according to the present disclosure, the other of: i) the one or more negative electrode tabs; and ii) the one or more positive electrode tabs, does not extend beyond the third end portion toward the first wall portion, and does not extend beyond the fourth end portion toward the second wall portion, in the second direction.

In the above-described configuration, the degree of sagging of the other tab can be reduced, so that contact between the other tab and the housing can be suppressed.

The secondary battery according to the present disclosure may further include an insulating member located between the housing and a sagging portion of the one of: i) the one or more negative electrode tabs; and ii) the one or more positive electrode tabs, and insulating the sagging portion and the housing from each other.

In the above-described configuration, the sagging portion and the housing are insulated from each other by the insulating member, so that electrical conduction between the one electrode tab and the housing can be suppressed.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a perspective view of a secondary battery according to a first embodiment.

FIG. 2 is an exploded perspective view of the secondary battery according to the first embodiment.

FIG. 3 is a cross-sectional view taken along the line III-III shown in FIG. 1.

FIG. 4 is a cross-sectional view taken along the line IV-IV shown in FIG. 1.

FIG. 5 is a cross-sectional view of the secondary battery showing a connection state of a positive electrode tab and a negative electrode tab according to the first embodiment.

FIG. 6 is a cross-sectional view of a secondary battery showing a connection state of a positive electrode tab and a negative electrode tab according to a second embodiment.

FIG. 7 is a cross-sectional view of a secondary battery showing a connection state of a positive electrode tab and a negative electrode tab according to a third embodiment.

### DESCRIPTION OF THE PREFERRED EMBODIMENTS

Hereinafter, embodiments of the present disclosure will be described in detail with reference to the drawings. In the following embodiments, the same or common portions are denoted by the same reference numerals, and description thereof will not be repeated.

### Embodiment 1

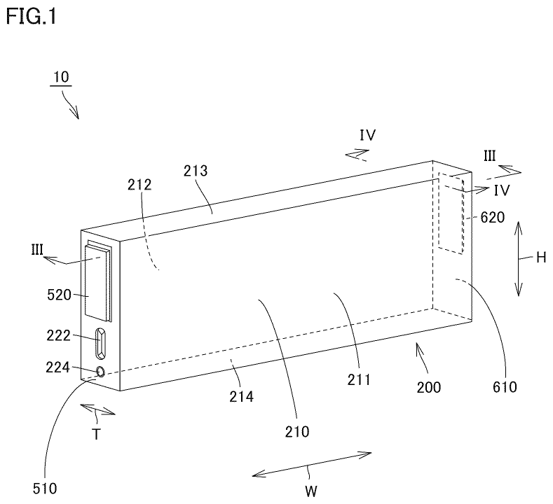

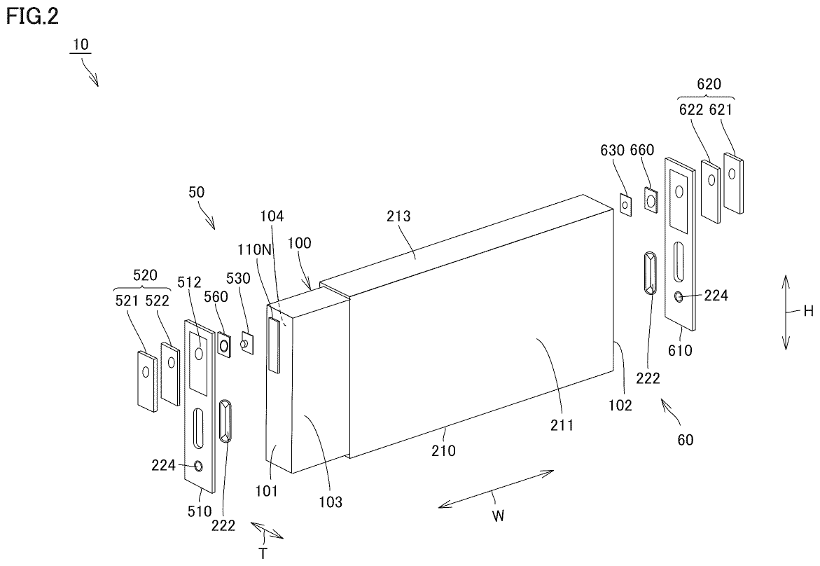

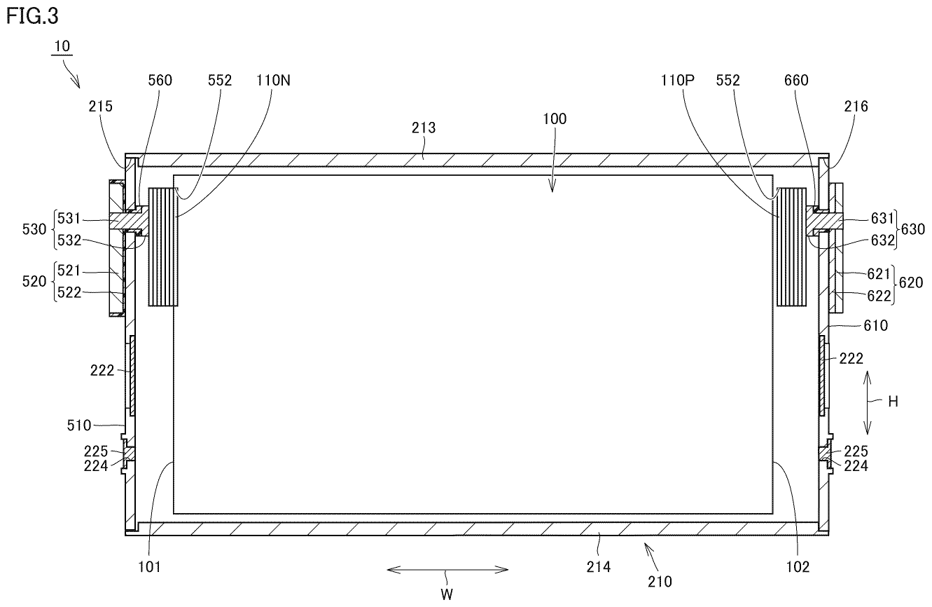

FIG. 1 is a perspective view of a secondary battery according to a first embodiment. FIG. 2 is an exploded perspective view of the secondary battery according to the first embodiment. FIG. 3 is a cross-sectional view taken along the line III-III shown in FIG. 1.

As shown in FIGS. 1 to 3, the secondary battery 10 according to the first embodiment includes an electrode assembly 100, a housing 200, a positive electrode member 620 as a positive electrode terminal, and a negative electrode member 520 as a negative electrode terminal.

The electrode assembly 100 has a first end portion 101 positioned on one side in the first direction and a second end portion 102 positioned on the other side in the first direction. The first direction is a direction parallel to a width direction W described later. The first end portion 101 is provided with a plurality of negative electrode tabs 110N. The second end portion 102 is provided with a plurality of positive electrode tabs 110P.

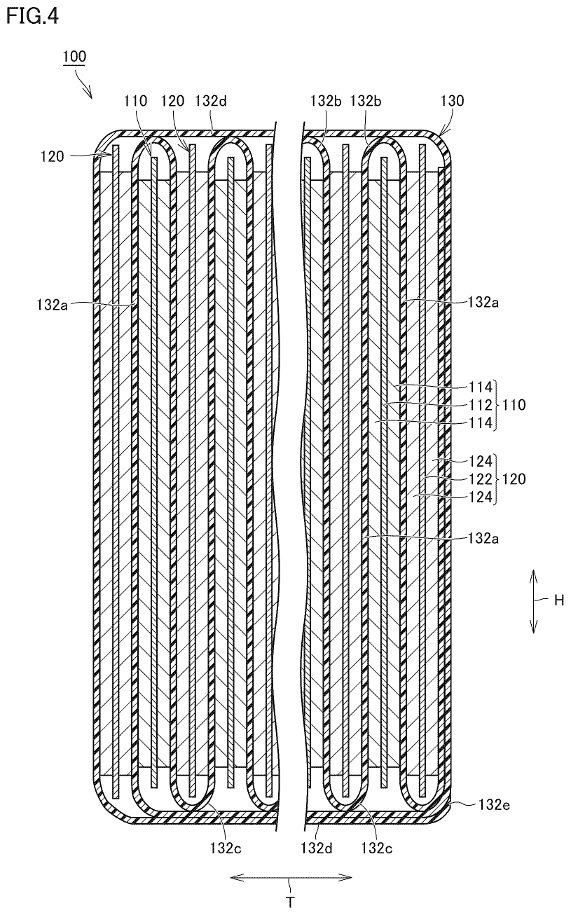

The electrode assembly 100 has a third end portion 103 positioned on one side in the second direction orthogonal to the first direction and a fourth end portion 104 positioned on the other side in the second direction. The second direction is a direction parallel to a thickness direction T described later. The detailed configuration of the electrode assembly 100 will be described later with reference to FIG. 4.

The housing 200 has a rectangular parallelepiped shape in which the thickness in the thickness direction T is smaller than the width in the width direction W and the height in the height direction H. The thickness direction T is parallel to a parallel direction in which a positive electrode 110 (see FIG. 4) and a negative electrode 120 (see FIG. 4) described later are arranged side by side. The width direction W is orthogonal to the thickness direction T. The height direction H is orthogonal to the thickness direction T and the width direction W. The width of the housing 200 in the width direction W is larger than the height of the housing 200 in the height direction H, and the width direction W is the longitudinal direction of the housing 200, and the height direction H is the lateral direction of the housing 200.

The housing 200 contains the electrode assembly 100 and an electrolyte solution (not shown) therein. The housing 200 includes a main body 210, a first sealing body 510, and a second sealing body 610.

The main body 210 has a cylindrical shape in which a first opening 215 and a second opening 216 are respectively provided on both sides in the width direction W. More specifically, the main body 210 has a quadrangular tube shape in which both sides in the width direction W are open. The first opening 215 is provided on one side in the width direction W, and the second opening 216 is provided on the other side in the width direction W. The main body 210 is made of metal such as aluminum.

The main body 210 includes a first wall portion 211 and a second wall portion 212 opposed to each other in the thickness direction T, and a third wall portion 213 and a fourth wall portion 214 opposed to each other in the height direction H. The areas of the first wall portion 211 and the second wall portion 212 are larger than those of the third wall portion 213 and the fourth wall portion 214.

The first wall portion 211 is disposed to face the third end portion 103 of the electrode assembly 100, and the second wall portion 212 is disposed to face the fourth end portion 104 of the electrode assembly 100. The third wall portion 213 is positioned on one side (upper side) in the height direction H. The third wall portion 213 connects end portions of the first wall portion 211 and the second wall portion 212 positioned on one side in the height direction H. The fourth wall portion 214 is positioned on the other side (lower side) in the height direction H. The fourth wall portion 214 connects the end portions of the first wall portion 211 and the second wall portion 212 positioned on the other side in the height direction H.

The first sealing body 510 closes the first opening 215. The first sealing body 510 has a flat plate shape. The first sealing body 510 is made of metal such as aluminum. The first sealing body 510 is fixed to the first opening 215 by, for example, laser welding.

The second sealing body 610 closes the second opening 216. The second sealing body 610 has a flat plate shape. The second sealing body 610 is made of metal such as aluminum. The second sealing body 610 is fixed to the second opening 216 by, for example, laser welding.

Each of the first sealing body 510 and the second sealing body 610 is provided with a pressure release valve 222 and a liquid injection port 224. The pressure release valve 222 is provided so as to break when the internal pressure of the housing 200 becomes equal to or higher than a predetermined pressure. When the pressure release valve 222 breaks, the gas in the housing 200 is discharged to the outside of the housing 200, so that the internal pressure in the housing 200 decreases.

The liquid injection port 224 is sealed by a sealing member 225. The liquid injection port 224 is a through hole for injecting an electrolyte solution into the housing 200 during the manufacturing process of the secondary battery 10. The liquid injection port 224 is sealed by a sealing member 225. The sealing member 225 seals the liquid injection port 224 after the electrolyte solution is injected into the housing 200. The sealing member 225 may be, for example, a gas-permeable membrane that transmits gas without transmitting liquid. In this case, when a gas generated at the time of charging is discharged to the outside of the housing 200, the gas can be discharged through the ventilation film. This eliminates the trouble of providing a separate gas vent. In addition, leakage of the electrolyte solution to the outside of the housing 200 can be suppressed by the ventilation film. Note that the sealing member 225 is not limited to a breathing film, and a resin member, a metal member, or the like can be adopted as appropriate.

The first sealing body 510 is provided with a negative electrode member 520, and the second sealing body 610 is provided with a positive electrode member 620.

The negative electrode member 520 is provided on the outer surface of the first sealing body 510. The negative electrode member 520 functions as a negative electrode terminal. The negative electrode member 520 includes a negative electrode terminal plate 521 and an insulating plate 522.

The negative electrode terminal plate 521 is formed in a substantially rectangular parallelepiped shape. The negative electrode terminal plate 521 is held by an insulating plate 522. The insulating plate 522 is fixed to the outer surface of the first sealing body 510. The insulating plate 522 insulates the first sealing body 510 from the negative electrode terminal plate 521. Each of the negative electrode terminal plate 521 and the insulating plate 522 is provided with a through hole through which a cylindrical portion 532 described later is inserted.

The positive electrode member 620 is provided on the outer surface of the second sealing body 610. The positive electrode member 620 functions as a positive electrode terminal. The positive electrode member 620 includes a positive electrode terminal plate 621 and a terminal block 622.

The positive electrode terminal plate 621 is formed in a rectangular parallelepiped shape. The positive electrode terminal plate 621 is made of a metal such as aluminum.

The terminal block 622 is formed in a rectangular parallelepiped shape. The terminal block 622 is made of a metal (e.g., iron) different from the metal constituting the positive electrode terminal plate 621. The terminal block 622 is fixed to the outer surface of the second sealing body 610 by welding or the like. The positive electrode terminal plate 621 is fixed to the terminal block 622 by welding or the like. The main body 210 and the second sealing body 610 are electrically connected to the positive electrode terminal plate 621 via the terminal block 622, and are charged to the same polarity as the positive electrode terminal plate 621. Each of the positive electrode terminal plate 621 and the terminal block 622 is formed with a through hole through which a cylindrical portion 632 described later is inserted.

An insulating plate may be disposed between the positive electrode member 620 and the second sealing body 610 to electrically insulate the positive electrode member 620 from the second sealing body 610. In this case, an insulating plate may be disposed instead of the terminal block 622, or an insulating plate may be disposed between the terminal block 622 and the second sealing body 610.

The secondary battery 10 further includes a negative electrode side conductive member 530 and an insulator 560 on the negative electrode member 520 side.

The negative electrode side conductive member 530 connects the plurality of negative electrode tabs 110N and the negative electrode terminal plate 521. The plurality of negative electrode tabs 110N are connected to the negative electrode side conductive member 530 in a bundled state by ultrasonic welding or the like. The negative electrode side conductive member 530 includes a plate-shaped portion 531 and a cylindrical portion 532. The plate-shaped portion 531 is substantially parallel to the inner surface of the first sealing body 510. The cylindrical portion 532 extends along a direction parallel to the first direction. The distal end portion of the cylindrical portion 532 penetrates the first sealing body 510, the insulating plate 522, and the negative electrode terminal plate 521, and is caulked to the negative electrode terminal plate 521.

The insulator 560 is disposed between the plate-shaped portion 531 and the first sealing body 510, and is insulated from the plate-shaped portion 531 and the first sealing body 510. The insulator 560 includes a portion that covers the periphery of the base end side of the cylindrical portion 532, and a portion positioned between the plate-shaped portion 531 and the inner surface of the first sealing body 510.

The negative electrode member 520, the first sealing body 510, the negative electrode side conductive member 530, and the insulator 560 are assembled to form the first lid assembly 50.

The first lid assembly 50 is fixed to the main body 210 by attaching the first sealing body 510 to the first opening 215 in a state where the plurality of negative electrode tabs 110N and the negative electrode side conductive member 530 are fixed by welding or the like.

The secondary battery 10 further includes a positive electrode side conductive member 630 and an insulator 660 on the positive electrode member 620 side.

The positive electrode side conductive member 630 connects the plurality of positive electrode tabs 110P and the positive electrode terminal plate 621. The plurality of positive electrode tabs 110P are connected to the positive electrode side conductive member 630 in a bundled state by ultrasonic welding or the like. The positive electrode side conductive member 630 includes a plate-shaped portion 631 and a cylindrical portion 632. The plate-shaped portion 631 is substantially parallel to the inner surface of the second sealing body 610. The cylindrical portion 632 extends along a direction parallel to the first direction. The tip portion of the cylindrical portion 632 penetrates the second sealing body 610, the terminal block 622, and the positive electrode terminal plate 621, and is caulked to the positive electrode terminal plate 621.

The insulator 660 is disposed between the plate-shaped portion 631 and the second sealing body 610, and is insulated from the plate-shaped portion 631 and the second sealing body 610. The insulator 660 includes a portion that covers the periphery of the base end side of the cylindrical portion 632, and a portion positioned between the plate-shaped portion 631 and the inner surface of the second sealing body 610.

The positive electrode member 620, the second sealing body 610, the positive electrode side conductive member 630, and the insulator 660 are assembled to form the second lid assembly 60.

The second lid assembly 60 is fixed to the main body 210 by attaching the second sealing body 610 to the second opening 216 in a state where the plurality of positive electrode tabs 110P and the positive electrode side conductive member 630 are fixed by welding or the like.

FIG. 4 is a cross-sectional view taken along the line IV-IV shown in FIG. 1. In FIG. 4, for the sake of convenience, the housing 200 of the secondary battery 10 is omitted, and only the electrode assembly 100 is shown. The details of the electrode assembly 100 will be described with reference to FIG. 4.

As shown in FIG. 4, the electrode assembly 100 includes a plurality of positive electrodes 110, a plurality of negative electrodes 120, and a separator 130. The plurality of positive electrodes 110 and the plurality of negative electrodes 120 are arranged alternately in the thickness direction T while being insulated by the separator 130.

Each of the negative electrodes 120 is formed in a rectangular shape in which the width direction W is the long side and the height direction H is the short side. Each negative electrode 120 includes a negative electrode current collector foil 122 and a negative electrode active material layer 124 provided on both surfaces of the negative electrode current collector foil 122. As shown in FIG. 4, the negative electrode current collector foil 122 has a negative electrode tab 110N in which the negative electrode active material layer 124 is not provided. The negative electrode tab 110N protrudes toward one side in the width direction W.

Each positive electrode 110 is formed in a rectangular shape in which the width direction W is the long side and the height direction H is the short side. Each positive electrode 110 includes a positive electrode current collector foil 112, and positive electrode active material layers 114 provided on both surfaces of the positive electrode current collector foil 112 in the thickness direction T. The positive electrode current collector foil 112 has a positive electrode tab 110P on which the positive electrode active material layer 114 is not provided. The positive electrode tab 110P protrudes toward the other side in the width direction W.

The separator 130 insulates the positive electrode 110 from the negative electrode 120. The separator 130 is made of an insulating material, and has minute voids that allow penetration of ions. The separator 130 is folded.

The separator 130 has a rectangular shape before being folded. The separator 130 is disposed between the positive electrode 110 and the negative electrode 120 in a folded state. The separator 130 includes a plurality of intervening portions 132a, a plurality of first folded portions 132b, a plurality of second folded portions 132c, and an outermost covering portion 132d.

The intervening portions 132a are interposed between the positive electrode 110 and the negative electrode 120 adjacent to each other in the thickness direction T. That is, each intervening portion 132a has a function of insulating the positive electrode 110 and the negative electrode 120. Each intervening portion 132a is configured by a rectangular region.

The first folded portions 132b connect one end of the intervening portions 132a in the height direction H adjacent to each other in the thickness direction T so that the positive electrodes 110 are positioned therebetween. The first folded portion 132b is disposed on one side (upper side) in the height direction H of the positive electrode 110.

The second folded portions 132c connect the other end portions of the intervening portions 132a adjacent to each other in the thickness direction T in the height direction H so that the negative electrodes 120 are positioned therebetween. The second folded portion 132c is disposed on the other side (lower side) of the negative electrode 120 in the height direction H.

The outermost covering portions 132d collectively cover the first folded portions 132b and the second folded portions 132c. More specifically, the outermost covering portion 132d covers all of the positive electrodes 110, all of the negative electrodes 120, all of the intervening portions 132a, all of the first folded portions 132b, and all of the second folded portions 132c while winding around the central axis parallel to the width direction W. The terminal end 132e of the outermost covering portion 132d is set in a range not overlapping the positive electrode active material layer 114 and the negative electrode active material layer 124 in the thickness direction T. In the present embodiment, the terminal end 132e of the outermost covering portion 132d is provided below each positive electrode 110 and each negative electrode 120. The peripheral surfaces and bottom surfaces of the plurality of positive electrodes 110, the plurality of negative electrodes 120, and the separator 130 may be covered with an insulating film (not shown).

FIG. 5 is a cross-sectional view of the secondary battery showing a connection state of a positive electrode tab and a negative electrode tab according to the first embodiment. FIG. 5 is a cross-sectional view taken along the line V-V shown in FIG. 3.

As shown in FIG. 5, each of the plurality of negative electrode tabs 110N is longer than each of the plurality of positive electrode tabs 110P. The plurality of negative electrode tabs 110N have a sagging portion 110T. The plurality of negative electrode tabs 110N sag to a greater extent than the plurality of positive electrode tabs 110P.

Any of the plurality of negative electrode tabs 110N includes a portion sagging away from the third end portion 103 of the electrode assembly 100, toward the first wall portion 211.

Among the plurality of negative electrode tabs 110N, the negative electrode tab 110N located on the side (the other side in the second direction) opposite to the bulging side (one side in the second direction) where the sagging portion 110T bulges is curved in a substantially U shape. Specifically, the negative electrode tab 110N curves toward one side in the second direction, and then curves toward the other side in the second direction, as it extends from the electrode assembly 100 toward the first sealing body 510.

Among the plurality of negative electrode tabs 110N, the negative electrode tab 110N located on the swelling side is curved in a substantially S shape. Specifically, as the negative electrode tab 110N extends from the electrode assembly 100 toward the first sealing body 510, the negative electrode tab 110N curves toward the other side in the second direction, and then bulges toward the one side in the second direction.

On the other hand, the plurality of positive electrode tabs 110P are provided so as not to extend beyond the third end portion 103 toward the first wall portion 211 and not to extend beyond the fourth end portion 104 toward the second wall portion 212 in the second direction (thickness direction T). Among the plurality of positive electrode tabs 110P, the positive electrode tab 110P located on the other side in the second direction is curved in a substantially U-shape, i.e., extends toward the one side in the second direction and then extends toward the other side in the second direction, as it extends from the electrode assembly 100 toward the second sealing body 610. Among the plurality of positive electrode tabs 110P, the positive electrode tab 110P located on the one side in the second direction curves toward the other side in the second direction, as it extends from the electrode assembly 100 toward the second sealing body 610.

Thus, the plurality of negative electrode tabs 110N are longer than the plurality of positive electrode tabs 110P. Therefore, when the first lid assembly 50 is assembled to the first opening 215 of the main body 210 after the second lid assembly 60 is assembled to the second opening 216 of the main body 210, the first sealing body 510 can be fixed to the main body 210 while adjusting the degree of sagging of the plurality of negative electrode tabs 110N. As a result, at the time of assembling the first lid assembly, it is possible to suppress the whole electrode assembly 100 from being pulled toward one side (the first opening 215 side) in the first direction. As a result, the force applied to the electrode assembly 100 can be suppressed, and damage to the electrode assembly 100 can be suppressed.

Further, since the plurality of negative electrode tabs 110N sag more than the plurality of positive electrode tabs 110P, it is possible to more reliably suppress the force applied to the electrode assembly 100 when the first lid assembly 50 is assembled.

Further, since the plurality of negative electrode tabs 110N include a portion that sags closer to the first wall portion 211 than the third end portion 103, it is possible to secure a large degree of adjustment of the degree of sag. Thus, the electrode assembly 100 and the external terminal can be stably electrically connected to each other.

Further, since the plurality of positive electrode tabs 110P do not extend beyond the third end portion 103 toward the first wall portion 211 and do not extend beyond the fourth end portion 104 toward the second wall portion 212 in the second direction, the degree of sagging of the positive electrode tabs 110P can be reduced. Thus, contact between the plurality of positive electrode tabs 110P and the housing can be suppressed.

### Embodiment 2

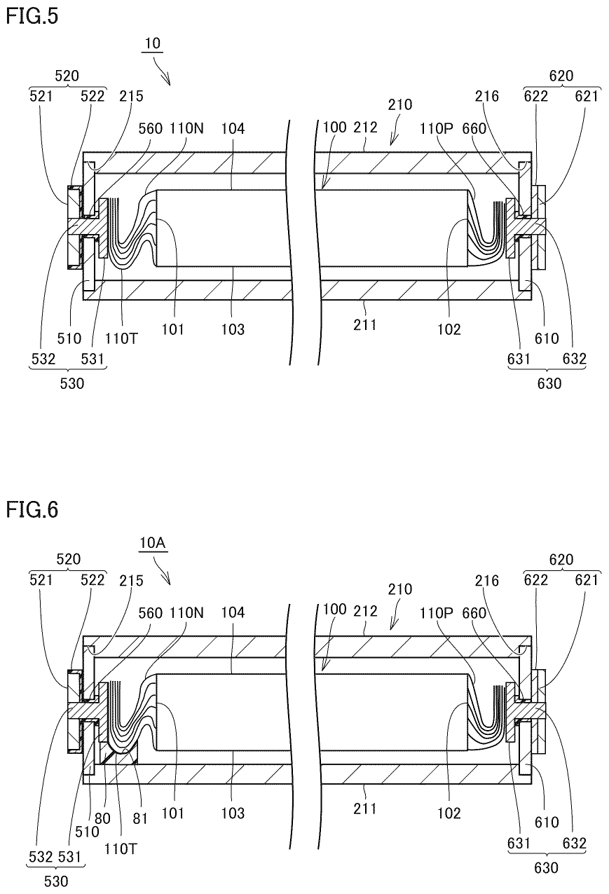

FIG. 6 is a cross-sectional view of a secondary battery showing a connection state of a positive electrode tab and a negative electrode tab according to a second embodiment. Specifically, FIG. 6 is a cross-sectional view of the secondary battery according to the second embodiment at a position corresponding to FIG. 5.

As shown in FIG. 6, the secondary battery 10A according to the second embodiment differs from the secondary battery 10 according to the first embodiment in that the secondary battery 10A includes an insulating member 80. The other configurations are substantially the same.

The insulating member 80 is disposed between the sagging portion 110T and the housing 200. The insulating member 80 is disposed between the wall of the main body 210 where the sagging portion 110T faces in the second direction and the sagging portion 110T. In the present embodiment, the insulating member 80 fills a gap between the sagging portion 110T and the first wall portion 211.

The insulating member 80 is provided along the sagging portion 110T and has a support surface 81 that supports the sagging portion 110T. The support surface 81 is, for example, a curved surface curved in a U-shape.

Even when the secondary battery 10A is configured as described above, the secondary battery 10A according to the second embodiment has substantially the same effect as the secondary battery 10 according to the first embodiment.

In addition, by providing the insulating member 80, the plurality of negative electrode tabs 110N and the housing 200 can be prevented from being brought into contact with each other and conductive. Since the insulating member 80 has the support surface 81, the movement of the plurality of negative electrode tabs 110N can be regulated. Thus, it is possible to prevent the sagging portion 110T from unintentionally contacting and conducting with the housing 200.

### Embodiment 3

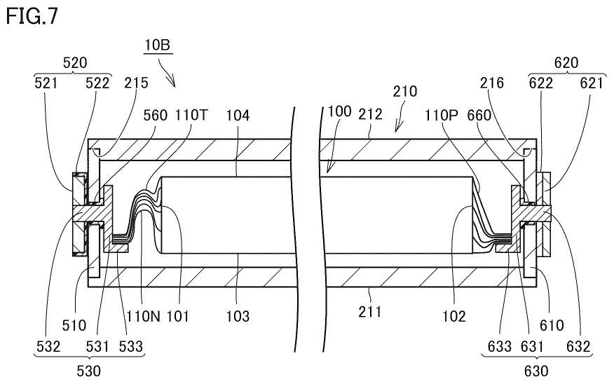

FIG. 7 is a cross-sectional view of a secondary battery showing a connection state of a positive electrode tab and a negative electrode tab according to a third embodiment. Specifically, FIG. 7 is a cross-sectional view of the secondary battery according to the third embodiment at a position corresponding to FIG. 5.

As shown in FIG. 7, the secondary battery 10B according to the third embodiment is different from the secondary battery 10 according to the first embodiment in the shapes of the negative electrode side conductive member 530 and the positive electrode side conductive member 630. The other configurations are substantially the same.

The negative electrode side conductive member 530 has a first extension 533 extending in the first direction toward the first end portion 101 of the electrode assembly 100. The first extension 533 is provided at an end portion of the plate-shaped portion 531 positioned on one side in the second direction. The first extension 533 has an outer main surface facing the first wall portion 211 and an inner main surface positioned on the opposite side to the outer main surface in the second direction.

The plurality of negative electrode tabs 110N are connected to the inner main surface of the first extension 533. The plurality of negative electrode tabs 110N have a curved portion that curves generally in a U-shape. The curved portion curves, as it extends from the electrode assembly 100 toward the first sealing body 510, so as to extend toward the opposite side to the side where the first extension 533 is located, and then toward the side where the first extension 533 is located, in the second direction. The curved portion forms a sagging portion of the plurality of negative electrode tabs 110N.

The positive electrode side conductive member 630 has a second extension 633 extending in the first direction toward the second end portion 102 of the electrode assembly 100. The second extension 633 is provided at an end portion of the plate-shaped portion 631 positioned on one side in the second direction. The second extension 633 has an outer main surface facing the first wall portion 211 and an inner main surface positioned opposite to the outer main surface in the second direction.

The plurality of negative electrode tabs 110N may be provided so as not to extend beyond the third end portion 103 toward the first wall portion 211 in the second direction (thickness direction T) and not to extend beyond the fourth end portion 104 toward the second wall portion 212.

The plurality of positive electrode tabs 110P are connected to the inner main surface of the second extension 633. The plurality of positive electrode tabs 110P are smaller in degree of sagging than the plurality of negative electrode tabs 110N.

The plurality of positive electrode tabs 110P may be provided so as not to extend beyond the third end portion 103 toward the first wall portion 211 in the second direction (thickness direction T) and not to extend beyond the fourth end portion 104 toward the second wall portion 212.

Even when the secondary battery 10B is configured as described above, the secondary battery 10B according to the third embodiment has substantially the same effect as the secondary battery 10 according to the first embodiment.

In the third embodiment, the case where the first extension 533 and the second extension 633 are provided at the end portions of the plate-shaped portions 531 and 631 positioned on one side in the second direction has been exemplified, but the present disclosure is not limited thereto. The first extension 533 and the second extension 633 may be provided at end portions of the plate-shaped portions 531 and 631 positioned on the other side in the second direction.

### (Other Modified Examples)

Although the case where the plurality of negative electrode tabs 110N are longer than the plurality of positive electrode tabs 110P is exemplified in the above-described first to third embodiments, the present disclosure is not limited thereto. The plurality of positive electrode tabs 110P may be longer than the plurality of negative electrode tabs 110N. In this case, when the second lid assembly 60 is assembled to the second opening 216 of the main body 210 after the first lid assembly 50 is assembled to the first opening 215 of the main body 210, the second sealing body 610 can be fixed to the main body 210 while adjusting the degree of sagging of the plurality of positive electrode tabs 110P. Thus, the force applied to the electrode assembly 100 when the second lid assembly 60 is assembled can be suppressed, and damage to the electrode assembly 100 can be suppressed.

Further, in the above case, the plurality of positive electrode tabs 110P may be larger than the plurality of negative electrode tabs 110N, and the insulating member 80 substantially similar to that of the second embodiment may be disposed between the sagging portion of the plurality of positive electrode tabs 110P and the housing 200.

In the above-described first and second embodiments, the case where the plurality of negative electrode tabs 110N includes a portion sagging toward the first wall portion 211, away from the third end portion 103 of the electrode assembly 100, is exemplified, but the present disclosure is not limited thereto. The plurality of negative electrode tabs 110N may include a portion sagging toward the second wall portion 212, away from the fourth end portion 104 of the electrode assembly 100. Also in this case, it is possible to secure a large margin for adjusting the degree of sagging, and it is possible to stably electrically connect the electrode assembly 100 and the external terminal.

Although the present disclosure has been described and illustrated in detail, it is clearly understood that the same is by way of illustration and example only and is not to be taken by way of limitation, the scope of the present disclosure being interpreted by the terms of the appended claims.

What is claimed is:

1. A secondary battery comprising:
an electrode assembly including a first end portion located on one side in a first direction, and a second end portion located on the other side in the first direction, one or more negative electrode tabs being formed on the first end portion, and one or more positive electrode tabs being formed on the second end portion;
a housing containing the electrode assembly; and
a negative electrode terminal and a positive electrode terminal that are provided on the housing, wherein
the housing includes:
a main body provided with a first opening on the one side in the first direction, and a second opening on the other side in the first direction;
a first sealing body closing the first opening; and
a second sealing body closing the second opening,
the negative electrode terminal is provided on the first sealing body,
the positive electrode terminal is provided on the second sealing body,
the one or more negative electrode tabs are electrically connected to the negative electrode terminal,
the one or more positive electrode tabs are electrically connected to the positive electrode terminal, and
one of: i) the one or more negative electrode tabs; and ii) the one or more positive electrode tabs, is larger in length than the other of: i) the one or more negative electrode tabs; and ii) the one or more positive electrode tabs.

2. The secondary battery according to claim 1, wherein the one of: i) the one or more negative electrode tabs; and ii) the one or more positive electrode tabs, sags to a greater extent than the other of: i) the one or more negative electrode tabs; and ii) the one or more positive electrode tabs.

3. The secondary battery according to claim 2, wherein
the main body includes a first wall portion and a second wall portion that are opposite to each other in a second direction orthogonal to the first direction,
the first wall portion is located on one side in the second direction,
the second wall portion is located on the other side in the second direction,
the electrode assembly includes a third end portion located on the one side in the second direction, and a fourth end portion located on the other side in the second direction,
the one of: i) the one or more negative electrode tabs; and ii) the one or more positive electrode tabs, includes a portion sagging away from the third end portion, toward the first wall portion, or a portion sagging away from the fourth end portion, toward the second wall portion.

4. The secondary battery according to claim 3, wherein the other of: i) the one or more negative electrode tabs; and ii) the one or more positive electrode tabs, does not extend beyond the third end portion toward the first wall portion, and does not extend beyond the fourth end portion toward the second wall portion, in the second direction.

5. The secondary battery according to claim 2, further comprising an insulating member located between the housing and a sagging portion of the one of: i) the one or more negative electrode tabs; and ii) the one or more positive electrode tabs, and insulating the sagging portion and the housing from each other.
